(19) United States
(12) Patent Application Publication
(10) Pub. No.: US 2014/0012942 A1
(43) Pub. Date: Jan. 9, 2014

(54) METHOD AND SYSTEM FOR REMOTE FACILITY AUDIT AND MANAGEMENT

(71) Applicants: Greg Lane Marshall, Schaumburg, IL (US); John William Scheeringa, Plainfield, IL (US)

(72) Inventors: Greg Lane Marshall, Schaumburg, IL (US); John William Scheeringa, Plainfield, IL (US)

(21) Appl. No.: 13/544,639

(22) Filed: Jul. 9, 2012

(51) Int. Cl. G06F 15/16

(52) U.S. Cl. 709/217

(57) ABSTRACT

A system and method for operating the same is disclosed in the present invention. Data are collected from remote facilities by data collecting devices, transmitted via means of data transmission to data server center for processing and compiling. The compiled data then are used to generate notifications and reports to clients interested in the remote facilities for the purpose of remote facility audit and management.

### BACKGROUND OF THE INVENTION

### Field of the Invention

The present invention relates to a system and method for remote monitoring. In particular, the present invention relates to a system and method of operating the same for remote facility audit and management.

Many companies have remotely operated facilities and remotely constructed projects. Such companies typically include cellular carriers, tower companies, turf vendors, and contractors and others. Since most of the projects have been moving so fast with sub-contractors of sub-contractors, these companies have little knowledge of the current site configuration and when people are performing work on site. Most of the remote facilities of these companies are operated in an unmanned fashion, there are great concerns of the securities of the materials and equipments at the remote facilities, such security risks includes vandalism, theft or natural severe weather conditions.

What is needed is a method and a system for tracking who is on site and/or on the tower, what is on the remote premise, and when it was changed or modified.

### SUMMARY OF THE INVENTION

In an exemplary embodiment of the present invention, there is disclosed a system and method for operating the same for remote facility audit and management. The system is comprised of remotely deployed data collecting devices installed or attached to the remote facilities, means for data transmission and communication, and data server center for data processing and compiling. The method for remote facility audit and management comprises 1) deploying the said system for the companies who have interests in remote facilities, 2) remotely operating the data collecting devices, 3) collecting data from remote facilities for these companies via data collecting devices, 4) transmitting and communicating the collected data to data server center, 5) processing and compiling the collected data at the data server center, and 6) notifying these companies the human activities such as man on tower detection, equipment modifications, additions, deletions, new construction, potential vandalism, theft, or other situations and/or providing material/equipment audits of the remote facilities.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a schematic illustration of the present invention as a system and method for operating the same for remote facility audit and management.

### DESCRIPTION OF THE PREFERRED EMBODIMENT

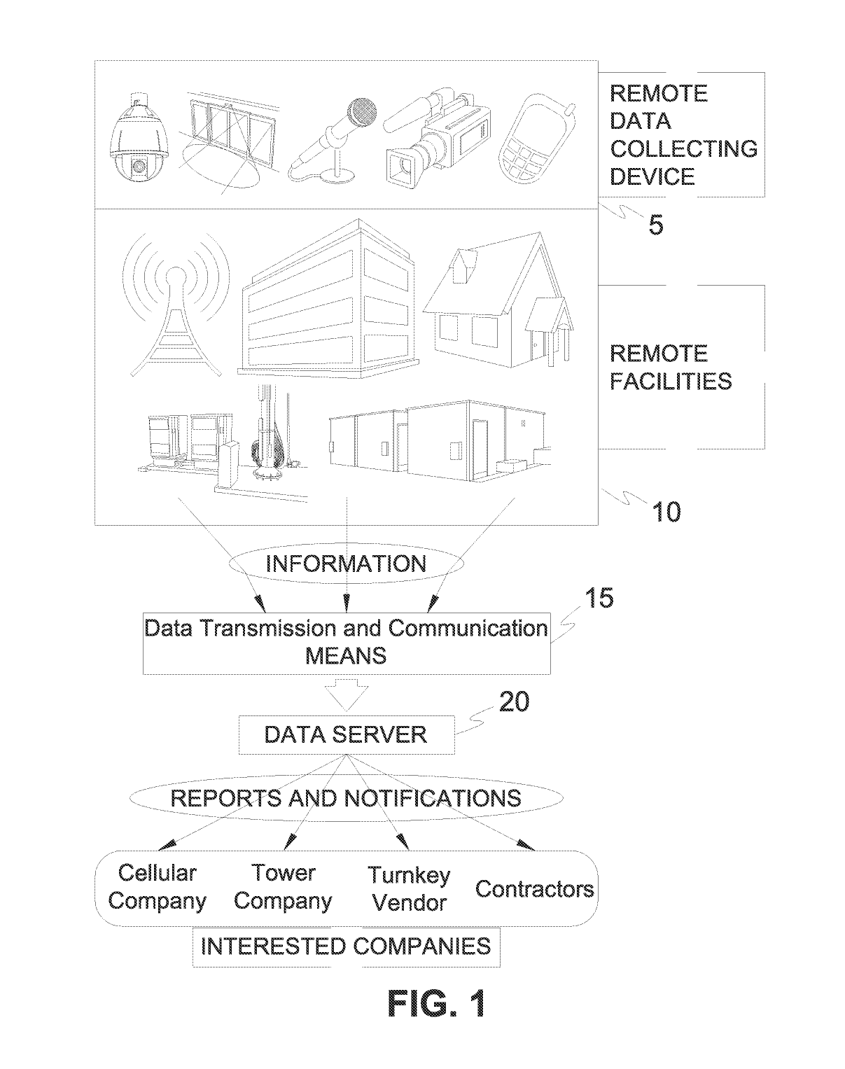

Referring to FIG. 1, there is disclosed a system and method for operating the same for remote facility audit and management. The system comprises of remotely deployed data collecting devices 5 installed or attached to the remote facilities 10, means for data transmission and communication 15, and data server center 20 for data processing and compiling.

In the presently disclosed system, one or multiple data collecting devices 5 in the present invention can be installed or attached to the remote facilities and towers. Such devices can include but not be limited to video cameras, audio, thermal imaging, PIR or other motion detection devices, in ground sensors, contact closures on shelter door(s), contact closures on both outdoor and indoor equipment cabinets, or any other device that can detect human presence around the facility compound. The remote facilities 10 in the present invention can include but not be limited to Data Centers, RF telecommunications towers, roof tops, water tanks, RF compound facilities including RF shelters, and outdoor telecommunication cabinets, telecommunication central offices, or any important unmanned telecommunication facility.

In the presently disclosed system, the means for data transmission and communication 15 are used to transmit or communicate the data collected by remote data collecting devices 5, such as video, audio, images, motion detection, gate contact closure, cabinet contact closure, shelter door contact closure, other contact closure(s), or any other information collected from the remote facilities to data server center 20 for data processing and compiling. The means for data transmission and communication can be any network method which could include IP packet, TDM, or any other method that can transmit or communicate the data collected from the remote facilities. Some methods could include broadband wireless, cable modems, private IP networks, the Internet, subscriber based networks, fiber optic networks, copper networks, or any other viable method of transmission of the information. The data can be encrypted, but does not have to be when transmitted between devices.

In the presently disclosed system, the data server center 20 can be one or more regional or national centers.

In one embodiment of the presently disclosed system, one camera is installed on Monopole with RAD center at top of pole. The said camera could account for all three sectors. One or more cameras could be at ground level and/or in shelters, one or more detection devices could have the capability to serve all carriers on tower and in the compound.

In another embodiment of the presently disclosed system, three cameras are installed for a Monopole, one for each sector, for a RAD center that is not at the top. If more than one Carrier was interested in this service offering, each Carrier could have cameras for each of their own RAD centers. One or more cameras at ground level and/or shelter, one or more detection devices could have the capability to serve all carriers on tower and in the compound.

In another embodiment of the presently disclosed system, three cameras are installed for a Guyed, one for each sector, for a RAD center that is not at the top. If more than one Carrier was interested in this service offering, each carrier could have cameras for each of their own RAD centers. One or more cameras at ground level and/or shelter, one or more detection devices could have the capability to serve all carriers on tower and in the compound.

In another embodiment of the presently disclosed system, three cameras are installed for a Self Support, one for each sector, for a RAD center that is not at the top. If more than one Carrier was interested in this service offering, each carrier could have cameras for each of their own RAD centers. One or more cameras at ground level and/or shelter, one or more detection devices could have the capability to serve all carriers on tower and in the compound.

In another embodiment of the presently disclosed system, cameras are installed in a customized manner on rooftop based on the antenna placement/configuration. Each site could require one camera per sector and additional cameras could be required to cover all entry and exit points on the roof for security purposes.

In another embodiment of the presently disclosed system, cameras are installed in a customized manner to water tanks based on the antenna placement/configuration. Each site could require one camera per sector and additional cameras could be required to cover all entry and exit points for security purposes.

Also referring to FIG. 1, there is disclosed a method for operating the said system for remote facility audit and management. The method comprises 1) deploying the said system for the companies who have interests in remote facilities, 2) remotely operating the data collecting devices, 3) collecting data from remote facilities for these companies via data collecting devices, 4) transmitting and communicating the collected data to data server center, 5) processing and compiling the collected data at the data server center, and 6) notifying these companies the human activities such as man on tower detection, equipment modifications, additions, deletions, new construction, potential vandalism, theft, or other situations and/or providing material/equipment audits of the remote facilities.

In the presently disclosed method, the data collecting devices installed or attached to the remote facilities are used to collect data from remote facilities. Such data collecting devices can include but not be limited to video cameras, audio, thermal imaging, PIR or other motion detection devices, in ground sensors, contact closures on shelter door(s), contact closures on both outdoor and indoor equipment cabinets, or any other device that can detect human presence around the facility compound. The data collected via these devices can be video, audio, images, motion detection, gate contact closure, cabinet contact closure, shelter door contact closure, other contact closure(s), or any other information collected from the remote facilities. The remote facilities to where the data collecting devices are installed or attached and from where the data are collected can include but not be limited to Data Centers, RF telecommunications towers, roof tops, water tanks, RF compound facilities including RF shelters, and outdoor telecommunication cabinets, telecommunication central offices, or any important unmanned telecommunication facility.

In the presently disclosed method, the data collecting devices are connected, and the data collected by these data collecting devices are transmitted to data server center via means of data transmitting and communicating. The means for data transmission and communication can be any network method which could include IP packet, TDM, or any other method that can transmit or communicate the data collected from the remote facilities. Some methods could include broadband wireless, cable modems, private IP networks, the Internet, subscriber based networks, fiber optic networks, copper networks, or any other viable method of transmission of the information. The data can be encrypted, but does not have to be when transmitted between devices.

In the presently disclosed method, after data collected from the remote facilities are transmitted via means of transmitting and communicating to the data server center which can be one or more regional or national centers, the data could be passed through to the client via real time video and/or processed and compiled at the said data server center.

Different methods are used to process and compile data collected from remote facilities according to clients' goals. For example, to capture any and all equipment/material modifications and/or additions/deletions that have occurred either on the remote towers, buildings, shelters, or other structures within the remote compounds, an algorithm has been created to compare electronic images from the day before any modifications/additions/deletions were detected and compare data of any and all activities of the day activity detection occurred. The algorithm output using pixel and other data point comparison will produce reports, alerts, etc., outlining any and all changes that occurred at any given location. As part of the algorithm function, precautions are built into the logic to account for and consider gate openings and man on tower activity to eliminate or reduce the number of image comparisons required to capture real activity from false readings that can occur due to in climate weather such as snow on the equipment. All captured activity either by the algorithm or by human supervision will be collected and reported to all interested parties.

Another example is to use multiple preset in combination with time lapse camera functionality. Custom software scripts were developed to control a Pan Tilt Zoom (PTZ) camera to cycle through specified preset positions within each hour and take a snapshot for each and send the photo image file where it can be combined with others to create time lapse photography. The combination of telling the camera to move to a specific position and take a time lapse snapshot allows creation of multiple time lapse video views. When the camera is commanded to take a snapshot it names the file for that photo by it's PTZ Position Number along with the time and date. This allows assembly of many photos into separate time lapse video archive streams. A single camera or each camera in a large system could produce more time lapse videos and each having multiple views and thus creating multiple time lapse videos from each.

After data collected from remote facilities has been processed and compiled, notifications and/or reports are generated from the compiled data and provided to companies with interests in those remote facilities (client). The compiled data from the remote facilities could trigger alarms and other desired notifications related to the aforementioned human activities for the purpose of distributing information to any client's designated Network Operations Centers, data servers, or other designated facility or entities of choice to help support their maintenance, construction and or audit activities, either real time, on a defined periodic schedule, or as poled by the client. A portion of the compiled data will also be used to generate a repeating video showing last activity, a time lapse function that will be made available indicating time and date stamps of all human activity on the tower such as tower maintenance, equipment expansions and/or modifications, and all other activity in the facility compound and shelter. Store and compare functions from captured video will also be made available to clients to facilitate check and balances for all work performed over a specified period of time.

In one embodiment of the presently disclosed method, the method is used and the notifications and reports are provided for the purpose of real time up-to-date equipment/material audits for tower top, shelters, and outdoor cabinets. The notifications and reports could 1) provide immediate checks and balances by comparing data stored in data bases such as Siterra, etc; 2) improve RF design with an accurate RFDS; 3) improved system performance; 4) shorten deployment schedules; 5) reduces trips to site and deployment costs; or/and 6) improve customer satisfaction.

In another embodiment of the presently disclosed method, the method is used and the notifications and reports are provided for the purpose of monitoring tower climbing. Real time or delayed time lapse video in conjunction with real time or delayed alert messaging for all tower climbing activities can be sent to the client's data server (Regional or National NOC) via multi media of choice. The notifications and reports could 1) provide immediate notification of someone on tower; 2) trigger monitoring and documentation activities for all equipment modifications, adds, and deletions as they occur; 3) capture actual dates that equipment/material was installed on the tower to enforce accurate dates that trigger new lease amendments. It will aid in keeping tenants honest regarding installation dates to minimize lost monthly reoccurring revenues; 4) monitor and document if proper climbing protocols and safety standards were followed. This will offer the ability of the tower owner to take immediate action to mitigate climbing accidents and/or deaths; 5) ensure/enforce proper construction and equipment installation standards are followed without being on site; or/and 6) monitor daily construction activities remotely for multiple site locations. Split screen mode will allow user to view multiple construction sites on one screen real time.

In another embodiment of the presently disclosed method, the method is used and the notifications and reports are provided for the purpose of monitoring construction activities. Real time or delayed time lapse video in conjunction with real time or delayed alert messaging for all construction activities and equipment/material modifications can be sent to the client's data server (Regional or National NOC) via multi media of choice. The notifications and reports could be use by the clients for the purpose of 1) verifying and monitoring construction activities without personnel on site—bringing immediate accountability to contractor with less effort; 2) verifying installation quality standards are being met real time without being on site and without the need for tower climbers for tower top inspections; 3) verifying proper safety standards are being met during construction—either real time or capture history for later review; 4) verify if the correct material/equipment is being installed properly without the need of visiting the site; 5) monitoring daily construction activities remotely for multiple site locations using split screen mode to view multiple construction sites on one screen real time; 6) determining daily progress by construction crew by using image overlay function; or/and 7) generating historical records of weather conditions and effect on construction, when crews were on site, or when milestone phases were completed.

In another embodiment of the presently disclosed method, the method is used and the notifications and reports are provided for the purpose of monitoring maintenance activities. Real time or delayed time lapse video in conjunction with real time or delayed alert messaging for all maintenance activities can be sent to the client's data server (Regional or National NOC) via multi media of choice. The notifications and reports could be used by the clients for the purpose of 1) aiding RF and Operations in trouble shooting poor cell site performance after inclement weather. Time Lapse in conjunction with real time video can aid personnel in determining if there is damaged equipment on ground level or on tower without a site visit; or/and 2) monitor vendor/contractor work to improve productivity by accurately assessing activities that can slow production without a site visit.

In another embodiment of the presently disclosed method, the method is used and the notifications and reports are provided for the purpose of security. Real time or delayed time lapse video in conjunction with real time or delayed alert messaging for security purpose can be sent to the client's data server (Regional or National NOC) via multi media of choice. The notifications and reports could be used by the clients for the purpose of 1) capturing activities associated with theft and vandalism that provide a deterrent and lead to more convictions. Extremely bright lights and/or sirens can be activated when activity is detected in restricted areas. Video images can be forwarded on such occurrences for human analysis and to enable further action to be taken if required; 2) minimizing repeat offenders and occurrences in known crime areas; 3) discouraging contractors and hired help from stealing or removing equipment without authorization; 4) improving equipment inventory management by determining if equipment was actually delivered to site location and verifying equipment delivery dates; 5) recording vehicles as they enter/exit site; and/or 6) verifying work site is locked up properly.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method for remote facilities audit and management comprising:
a) deploying a system for remote facilities audit and management comprising
i. data collecting devices, installed or attached to the remote facilities;
ii. means for data transmission and communication; and
iii. data server center, for data processing and compiling;
b) remotely operating the data collecting devices;
c) collecting data from remote facilities for these companies via data collecting devices;
d) transmitting and communicating the collected data via means for data transmission and communication to data server center;
e) processing and compiling the collected data at the data server center; and
f) providing notifications and reports to clients with interests, such as but not limited to human activities, material/equipment audits, equipment modifications, additions, deletions, new construction, potential vandalism, theft, or other situations, in the remote facilities.

2. A method of claim 1, wherein
the said data collecting devices can include but not be limited to video cameras, audio, thermal imaging, PIR or other motion detection devices, in ground sensors, contact closures on shelter door(s), contact closures on both outdoor and indoor equipment cabinets, or any other device that can detect human presence around the facility compound;
the said means for data transmission and communication include but not limit to IP packet, TDM, or any other method that can transmit or communicate the data collected from the remote facilities such as broadband wireless, cable modems, private IP networks, the Internet, subscriber based networks, fiber optic networks, copper networks, or any other viable method of transmission of the information; and
the said data server center can be one or more regional or national centers.

3. A method of claim 2, wherein the data collected from the remote facilities includes but not limits to video, audio, images, motion detection, gate contact closure, cabinet contact closure, shelter door contact closure, other contact closure(s), or any other information collected from the remote facilities; and the data can be encrypted, but does not have to be when transmitted between devices.

4. A method of claim 2, wherein the remote facilities include not limit to Data Centers, RF telecommunications towers, roof tops, water tanks, RF compound facilities including RF shelters, and outdoor telecommunication cabinets, telecommunication central offices, or any important unmanned telecommunication facility.

5. A method of claim 2, wherein the said method is used and the notifications and reports are provided for the purpose of real time up-to-date equipment/material audits for tower top, shelters, and outdoor cabinets;said notifications and reports could 1) provide immediate checks and balances by comparing data stored in data bases such as Siterra, etc; 2) improve RF design with an accurate RFDS; 3) improved system performance; 4) shorten deployment schedules; 5) reduces trips to site and deployment costs; or/and 6) improve customer satisfaction.

6. A method of claim 2, wherein the said method is used and the notifications and reports are provided for the purpose of tower climbing monitoring; real time or delayed time lapse video in conjunction with real time or delayed alert messaging for all tower climbing activities can be sent to the client's data server (Regional or National NOC) via multi media of choice and split screen mode will allow user to view multiple construction sites on one screen real time; said notifications and reports could 1) provide immediate notification of someone on tower; 2) trigger monitoring and documentation activities for all equipment modifications, adds, and deletions as they occur; 3) capture actual dates that equipment/material was installed on the tower to enforce accurate dates that trigger new lease amendments. It will aid in keeping tenants honest regarding installation dates to minimize lost monthly reoccurring revenues; 4) monitor and document if proper climbing protocols and safety standards were followed. This will offer the ability of the tower owner to take immediate action to mitigate climbing accidents and/or deaths; 5) ensure/enforce proper construction and equipment installation standards are followed without being on site; or/and 6) monitor daily construction activities remotely for multiple site locations.

7. A method of claim 2, wherein the said method is used and the notifications and reports are provided for the purpose of monitoring construction activities; real time or delayed time lapse video in conjunction with real time or delayed alert messaging for all construction activities and equipment/material modifications can be sent to the client's data server (Regional or National NOC) via multi media of choice; said notifications and reports could be use by the clients for the purpose of 1) verifying and monitoring construction activities without personnel on site—bringing immediate accountability to contractor with less effort; 2) verifying installation quality standards are being met real time without being on site and without the need for tower climbers for tower top inspections; 3) verifying proper safety standards are being met during construction—either real time or capture history for later review; 4) verify if the correct material/equipment is being installed properly without the need of visiting the site; 5) monitoring daily construction activities remotely for multiple site locations using split screen mode to view multiple construction sites on one screen real time; 6) determining daily progress by construction crew by using image overlay function; or/and 7) generating historical records of weather conditions and effect on construction, when crews were on site, or when milestone phases were completed.

8. A method of claim 2, wherein the said method is used and the notifications and reports are provided for the purpose of monitoring maintenance activities; real time or delayed time lapse video in conjunction with real time or delayed alert messaging for all maintenance activities can be sent to the client's data server (Regional or National NOC) via multi media of choice; said notifications and reports could be use by the clients for the purpose of 1) aiding RF and Operations in trouble shooting poor cell site performance after inclement weather. Time Lapse in conjunction with real time video can aid personnel in determining if there is damaged equipment on ground level or on tower without a site visit; or/and 2) monitor vendor/contractor work to improve productivity by accurately assessing activities that can slow production without a site visit.

9. A method of claim 2, wherein the said method is used and the notifications and reports are provided for the purpose of security and real time or delayed time lapse video in conjunction with real time or delayed alert messaging for security purpose can be sent to the client's data server (Regional or National NOC) via multi media of choice; said notifications and reports could be use by the clients for the purpose of 1) capturing activities associated with theft and vandalism that provide a deterrent and lead to more convictions. Extremely bright lights and/or sirens can be activated when activity is detected in restricted areas. Video images can be forwarded on such occurrences for human analysis and to enable further action to be taken if required; 2) minimizing repeat offenders and occurrences in known crime areas; 3) discouraging contractors and hired help from stealing or removing equipment without authorization; 4) improving equipment inventory management by determining if equipment was actually delivered to site location and verifying equipment delivery dates; 5) recording vehicles as they enter/exit site; or/and 6) verifying work site is locked up properly.

10. A system for remote facility audit and management comprising:
data collecting devices, installed or attached to the remote facilities;
means for data transmission and communication; and
data server center, for data processing and compiling.

11. A system of claim 10, wherein
the said remote facilities includes but not limited to Data Centers, RF telecommunications towers, roof tops, water tanks, RF compound facilities including RF shelters, and outdoor telecommunication cabinets, telecommunication central offices, or any important unmanned telecommunication facility;
the said data collecting devices includes but not limit to video cameras, audio, thermal imaging, PIR or other motion detection devices, in ground sensors, contact closures on shelter door(s), contact closures on both outdoor and indoor equipment cabinets, or any other device that can detect human presence around the facility compound; and
the said means data transmission and communication includes but not limited to IP packet, TDM, or any other method that can transmit or communicate the data collected from the remote facilities such as broadband wireless, cable modems, private IP networks, the Internet, subscriber based networks, fiber optic networks, copper networks, or any other viable method of transmission of the information.

12. A system of claim 11, wherein one camera is installed on Monopole with RAD center at top of pole, and said camera could account for all three sectors; one or more cameras could be at ground level and/or in shelters, one or more detection devices could have the capability to serve all carriers on towerand in the compound.

13. A system of claim 11, wherein three cameras are installed for a Monopole, one for each sector, for a RAD center that is not at the top; and if more than one Carrier was interested in this service offering, each Carrier could have cameras for each of their own RAD centers. One camera or more at ground level and/or shelter, one or more detection devices could have the capability to serve all carriers on tower and in the compound.

14. A system of claim 11, wherein three cameras are installed for a Guyed, one for each sector, for a RAD center that is not at the top; and if more than one Carrier was interested in this service offering, each carrier could have cameras for each of their own RAD centers; one or more cameras at ground level and/or shelter, one or more detection devices could have the capability to serve all carriers on tower and in the compound.

15. A system of claim 11, wherein three cameras are installed for a Self Support, one for each sector, for a RAD center that is not at the top; and if more than one Carrier was interested in this service offering, each carrier could have cameras for each of their own RAD centers; one or more cameras at ground level and/or shelter, one or more detection devices could have the capability to serve all carriers on tower and in the compound.

16. A system of claim 11, wherein cameras are installed in a customized manner to water tank based on the antenna placement/configuration, each site could require one camera per sector and additional cameras could be required to cover all entry and exit points on the roof for security purposes.

17. A system of claim 11, wherein cameras are installed in a customized manner to water tank based on the antenna placement/configuration, each site could require one camera per sector and additional cameras could be required to cover all entry and exit points on the roof for security purposes.
